(19) United States
(12) Patent Application Publication
(10) Pub. No.: US 2025/0090412 A1
(43) Pub. Date: Mar. 20, 2025

(54) MASSAGER WITH BETTER ADSORPTION EFFECT

(71) Applicant: Shenzhen Imoon Technology Co., Ltd., Shenzhen (CN)

(72) Inventor: Ru Chen, Shenzhen (CN)

(21) Appl. No.: 18/503,129

(22) Filed: Nov. 6, 2023

(30) Foreign Application Priority Data
Sep. 19, 2023 (CN) 202311214257.2

(51) Int. Cl. A61H 19/00; A61H 23/00; A61H 23/02

(52) U.S. Cl. CPC A61H 19/34; A61H 23/006; A61H 23/02

(57) ABSTRACT

Disclosed is a massager with better adsorption effect, falling within the technical field of adult health care products. The massager with better adsorption effect includes a massage head and a handle. The handle includes a housing, a control key and a driving assembly, the driving assembly being arranged in the housing and the control key being connected to the driving assembly, and a soft tongue portion, an upper lip and a lower lip are arranged on the massage head. The driving assembly includes a driving circuit board, a telescopic motor and a mounting frame, the mounting frame including a lantern ring, a connecting rod, a limit rod, an upper driving plate and a lower driving plate. The present disclosure has a simple structure and a humanization design, and the human-imitation action is close to the real action effect of human beings, which brings a better experience to a user.

### CROSS-REFERENCE TO RELATED APPLICATIONS

This application claims priority of Chinese Patent Application No. 202311214257.2, filed on Sep. 19, 2023, the entire contents of which are incorporated herein by reference.

### TECHNICAL FIELD

The present disclosure relates to the technical field of adult health care products, in particular to a massager with better adsorption effect.

### BACKGROUND

With the improvement of living standards and the increasing pressure in people's life and work, adult health care products are welcomed by a growing number of people. People are also putting more and more energy into health and comfort in life. Accordingly, various health care and massage products specially designed for adults have been popularized and applied. A simulated female massager is a very common one, which provides the possibility of releasing some pressure for single adult women or women who have been separated from spouses for a long time. A traditional simulated massager not only includes a simulated massage body, but also has a vibration motor inside. Active massage is realized through motor driving, and the massager greatly improves the convenience of use and comfort.

However, most of the traditional massagers only have the function of vibration massage, and a small part of which have the function of imitating human action. However, the function of imitating human action is often difficult to achieve the effect close to the real human action, so it is not humanized enough, bringing users imperfect experience and feelings.

### SUMMARY

In view of the above defects of the prior art, the present disclosure provides a massager with better adsorption effect. The present disclosure has a simple structure and a humanization design, and the human-imitation action is close to the real action effect of human beings, which brings a better experience to a user.

In order to realize the above object, the technical solutions adopted by the present disclosure are as follows.

A massager with better adsorption effect includes a massage head and a handle. The handle includes a housing, a control key and a driving assembly, the driving assembly being arranged in the housing and the control key being connected to the driving assembly, and a soft tongue portion, an upper lip and a lower lip are arranged on the massage head. The driving assembly includes a driving circuit board, a telescopic motor and a mounting frame, the driving circuit board being electrically connected to the telescopic motor, and the mounting frame including a lantern ring, a connecting rod, a limit rod, an upper driving plate and a lower driving plate. The lantern ring is sleeved on a movable rod of the telescopic motor and driven to move by the telescopic motor; one end of the connecting rod is rotatably connected to the lantern ring, and the other end of the connecting rod is connected to the soft tongue portion; an upper end of the limit rod is connected to the connecting rod, a lower end of the limit rod extends downwards, and the lower end of the limit rod is connected to a limit sleeve; one end of the upper driving plate is connected to the lantern ring, and the other end of the upper driving plate is connected to the upper lip; one end of the lower driving plate is connected to the lantern ring, and the other end of the lower driving plate is connected to the lower lip; and the upper lip and the lower lip are driven to open and close when the upper driving plate and the lower driving plate are driven by the telescopic motor to move.

In the above description, as a preference, two mounting plates arranged at intervals are arranged at a front end of the lantern ring, a first rotation shaft is arranged between the two mounting plates, a movable plate is arranged on the first rotation shaft, the connecting rod is rotatably mounted on the first rotation shaft via the movable plate, and an upper end of the limit rod is movably mounted at lower ends of the mounting plates.

In the above description, as a preference, the upper driving plate is mounted at an upper end of the lantern ring via a first arc-shaped mounting portion, and a side wall of the first arc-shaped mounting portion is rotatably mounted on an inner wall of the housing via a second rotation shaft.

In the above description, as a preference, a first movable hole is arranged at the inner wall of the housing, a first mounting groove is arranged at the first arc-shaped mounting portion, one end of the second rotation shaft is mounted on the first mounting groove, and the other end of the second rotation shaft is movably inserted into the first movable hole.

In the above description, as a preference, the lower driving plate is mounted to a lower end of the lantern ring via a second arc-shaped mounting portion, and a side wall of the second arc-shaped mounting portion is rotatably mounted to the inner wall of the housing via a third rotation shaft.

In the above description, as a preference, a second movable hole is arranged at the inner wall of the housing, a second mounting groove is arranged at the second arc-shaped mounting portion, one end of the third rotation shaft is mounted on the second mounting groove, and the other end of the third rotation shaft is movably inserted into the second movable hole.

In the above description, as a preference, an end of the upper driving plate extending to the upper lip inclines upwards from the inside to the outside, a first mounting slot for inserting the upper driving plate is arranged at an inner wall of the upper lip, and the upper driving plate is inserted into the first mounting slot and connected to the upper lip.

In the above description, as a preference, an end of the lower driving plate extending to the lower lip inclines downwards from the inside to the outside, a second mounting slot for inserting the lower driving plate is arranged at an inner wall of the lower lip, and the lower driving plate is inserted into the second mounting slot and connected to the lower lip.

In the above description, as a preference, a mounting jack for inserting and mounting the connecting rod is arranged at an inner wall of the soft tongue portion, and the connecting rod is inserted into the mounting jack and connected to the soft tongue portion.

The beneficial effects of the present disclosure are as follows. The lantern ring is sleeved on the movable rod of the telescopic motor and can be driven to move by the telescopic motor. One end of the connecting rod is rotatably connected to the lantern ring, and the other end of the connecting rod is connected to the soft tongue portion. The upper end of the limit rod is connected to the connecting rod, the lower end of the limit rod extends downwards, and the lower end of the limit rod is connected to the limit sleeve, so that the telescopic motor can drive the soft tongue portion to move to extend and retract via the connecting rod. At the same time, since the connecting rod is rotatably connected to the lantern ring, when the telescopic motor drives the lantern ring to drive the connecting rod to extend and retract, the connecting rod drives the soft tongue portion to move up and down. One end of the upper driving plate is connected to the lantern ring, and the other end of the upper driving plate is connected to the upper lip. One end of the lower driving plate is connected to the lantern ring, and the other end of the lower driving plate is connected to the lower lip. When the telescopic motor drives the upper driving plate and the lower driving plate to extend and retract, the upper lip and the lower lip are driven to open and close. The present disclosure has a simple structure and a humanization design, and the human-imitation action is close to the real action effect of human beings, which brings a better experience to a user.

### BRIEF DESCRIPTION OF THE DRAWINGS

FIG. 1 is a schematic diagram of an assembly structure according to an example of the present disclosure;

FIG. 2 is a schematic diagram of an exploded structure according to an example of the present disclosure;

FIG. 3 is a schematic diagram of an internal structure of a massage head according to an example of the present disclosure;

FIG. 4 is a schematic diagram of a cross-sectional structure according to an example of the present disclosure; and

FIG. 5 is a schematic diagram of a three-dimensional sectional structure according to an example of the present disclosure.

Reference numerals and denotations thereof: 10-massage head; 11-soft tongue portion; 12-upper lip; 13-lower lip; 14-mounting jack; 15-first mounting slot; 16-second mounting slot; 20-handle; 21-housing; 22-control key; 30-driving assembly; 31-driving circuit board; 32-telescopic motor; 33-mounting frame; 35-lantern ring; 351-mounting plate; 352-first rotation shaft; 353-movable plate; 36-connecting rod; 37-limit rod; 371-limit sleeve; 38-upper driving plate; 381-first arc-shaped mounting portion; 382-second rotation shaft; 383-first movable hole; 384-first mounting groove; 39-lower driving plate; 391-second arc-shaped mounting portion; 392-third rotation shaft; 393-second movable hole; and 394-second mounting groove.

### DETAILED DESCRIPTION

In order to more clearly explain structural features, technical means and specific objects and functions achieved by the present disclosure, the present disclosure will be described in further detail below with reference to the attached drawings and specific examples.

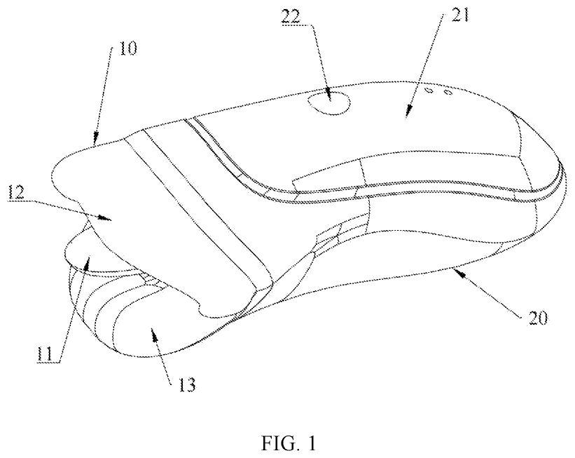

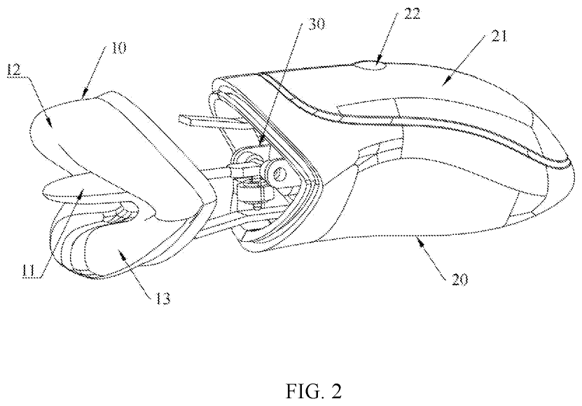

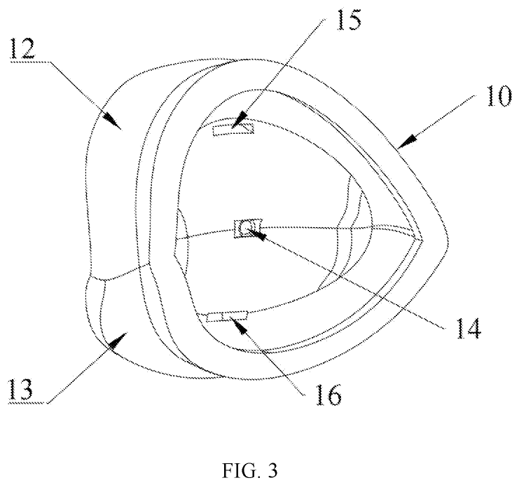

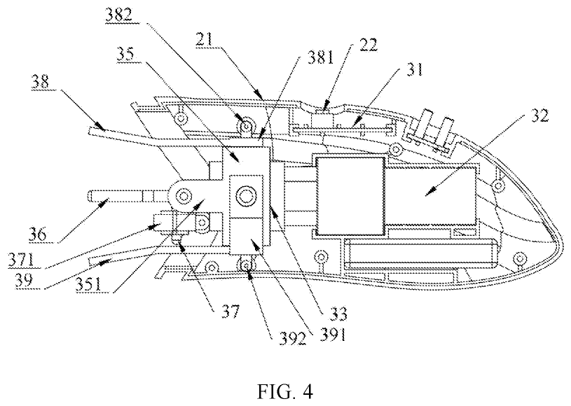

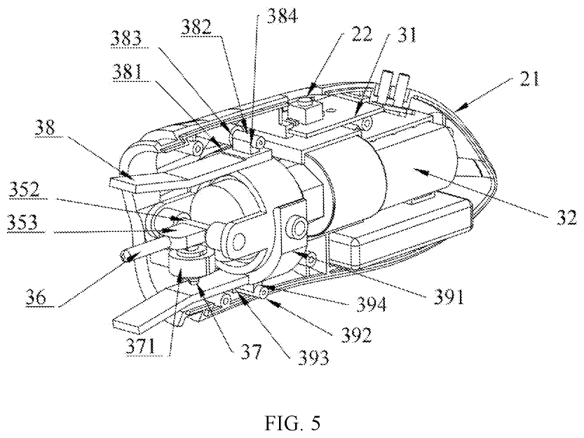

In an example, as shown in FIGS. 1-5, a massager with better adsorption effect includes a massage head 10 and a handle 20. The handle 20 includes a housing 21, a control key 22 and a driving assembly 30, the driving assembly 30 being arranged in the housing 21 and the control key 22 being connected to the driving assembly 30, and a soft tongue portion 11, an upper lip 12 and a lower lip 13 are arranged on the massage head 10. The driving assembly 30 includes a driving circuit board 31, a telescopic motor 32 and a mounting frame 33. One end of the control key 22 is connected to a control circuit board, the other end of the control key 22 passes through a side wall of the housing 21 and is exposed outwards, and the driving circuit board 31 is electrically connected to the telescopic motor 32.

The mounting frame 33 includes a lantern ring 35, a connecting rod 36, a limit rod 37, an upper driving plate 38 and a lower driving plate 39. The lantern ring 35 is sleeved on a movable rod of the telescopic motor 32 and driven to move by the telescopic motor 32. One end of the connecting rod 36 is rotatably connected to the lantern ring 35, and the other end of the connecting rod 36 is connected to the soft tongue portion 11. Two mounting plates 351 arranged at intervals are arranged at a front end of the lantern ring 35, a first rotation shaft 352 is arranged between the two mounting plates 351, a movable plate 353 is arranged on the first rotation shaft 352, the connecting rod 36 is rotatably mounted on the first rotation shaft 352 via the movable plate 353. A mounting jack 14 for inserting and mounting the connecting rod 36 is arranged at an inner wall of the soft tongue portion 11, and the connecting rod 36 is inserted into the mounting jack 14 and connected to the soft tongue portion 11, so that the telescopic motor 32 can drive the connecting rod 36 via the lantern ring 35 to drive the soft tongue portion 11 to extend and retract. An upper end of the limit rod 37 is movably mounted at lower ends of the mounting plates 351, a lower end of the limit rod 37 extends downwards, and the lower end of the limit rod 37 is connected to a limit sleeve 371. One end of the limit sleeve 371 is connected to the inner wall of the housing 21. When the telescopic motor 32 drives the lantern ring 35 to drive the connecting rod 36 to extend and retract, since the connecting rod 36 is rotatably connected to the lantern ring 35, the connecting rod 36 drives the soft tongue portion 11 to move up and down, and the up-and-down movement area of the soft tongue portion 11 is limited by the limit sleeve 371, so that the soft tongue portion 11 always moves up and down within a fixed range.

One end of the upper driving plate 38 is connected to the lantern ring 35, and the other end of the upper driving plate 38 is connected to the upper lip 12. An end of the upper driving plate 38 extending to the upper lip 12 inclines upwards from the inside to the outside, a first mounting slot 15 for inserting the upper driving plate 38 is arranged at an inner wall of the upper lip 12, and the upper driving plate 38 is inserted into the first mounting slot 15 and connected to the upper lip 12. The upper driving plate 38 is mounted at an upper end of the lantern ring 35 via a first arc-shaped mounting portion 381, and a side wall of the first arc-shaped mounting portion 381 is rotatably mounted on an inner wall of the housing 21 via a second rotation shaft 382. A first movable hole 383 is arranged at the inner wall of the housing 21, a first mounting groove 384 is arranged at the first arc-shaped mounting portion 381, one end of the second rotation shaft 382 is mounted on the first mounting groove 384, and the other end of the second rotation shaft 382 is movably inserted into the first movable hole 383. One end of the lower driving plate 39 is connected to the lantern ring 35, and the other end of the lower driving plate 39 is connected to the lower lip 13. An end of the lower driving plate 39 extending to the lower lip 13 inclines downwards from the inside to the outside, a second mounting slot 16 for inserting the lower driving plate 39 is arranged at an inner wall of the lower lip 13, and the lower driving plate 39 is inserted into the second mounting slot 16 and connected to the lower lip 13. The lower driving plate 39 is mounted at a lower end of the lantern ring 35 via a second arc-shaped mounting portion 391, and a side wall of the second arc-shaped mounting portion 391 is rotatably mounted on the inner wall of the housing 21 via a third rotation shaft 392. A second movable hole 393 is arranged at the inner wall of the housing 21, a second mounting groove 394 is arranged at the second arc-shaped mounting portion 391, one end of the third rotation shaft 392 is mounted on the second mounting groove 394, and the other end of the third rotation shaft 392 is movably inserted into the second movable hole 393. When the telescopic motor 32 drives the lantern ring 35 to retract backwards, the upper driving plate 38 and the lower driving plate 39 drive the upper lip 12 and the lower lip 13 to close; and when the telescopic motor 32 drives the lantern ring 35 to extend forwards, the upper driving plate 38 and the lower driving plate 39 drive the upper lip 12 and the lower lip 13 to open.

When in use, the telescopic motor 32 drives the lantern ring 35 to drive the connecting rod 36, the upper driving plate 38 and the lower driving plate 39 to protrude forwards, so that the upper lip 12 and the lower lip 13 are in an open state. At the same time, the soft tongue portion 11 protrudes forwards, and since the connecting rod 36 is rotatably connected to the lantern ring 35, the connecting rod 36 drives the soft tongue portion 11 to extend forwards and move up and down. The up-and-down movement area of the soft tongue portion 11 is limited by the limit sleeve 371, so that the soft tongue portion 11 always moves up and down within a fixed range. While the telescopic motor 32 drives the lantern ring 35 to drive the connecting rod 36, the upper driving plate 38 and the lower driving plate 39 to retract backwards, so that the upper lip 12 and the lower lip 13 are in a closed state. At the same time, the soft tongue portion 11 retracts backwards, and since the connecting rod 36 is rotatably connected to the lantern ring 35, the connecting rod 36 drives the soft tongue portion 11 to extend forwards and move up and down. The up-and-down movement area of the soft tongue portion 11 is limited by the limit sleeve 371, so that the soft tongue portion 11 always moves up and down within a fixed range. The present disclosure has a simple structure and a humanization design, and the human-imitation action is close to the real action effect of human beings, which brings a better experience to a user.

The above is only the preferred example of the present disclosure, and does not limit the present disclosure. Therefore, any modification, equivalent substitution and improvement made to the above example according to the technical solutions of the present disclosure still fall within the scope of the technical solutions of the present disclosure.

1. A massager with better adsorption effect, comprising a massage head and a handle, wherein
the handle comprises a housing, a control key and a driving assembly, the driving assembly being arranged in the housing and the control key being connected to the driving assembly, and a soft tongue portion, an upper lip and a lower lip are arranged on the massage head;
the driving assembly comprises a driving circuit board, a telescopic motor and a mounting frame, the driving circuit board being electrically connected to the telescopic motor, and the mounting frame comprising a lantern ring, a connecting rod, a limit rod, an upper driving plate and a lower driving plate;
the lantern ring is sleeved on a movable rod of the telescopic motor and driven to move by the telescopic motor; one end of the connecting rod is rotatably connected to the lantern ring, and the other end of the connecting rod is connected to the soft tongue portion; an upper end of the limit rod is connected to the connecting rod, a lower end of the limit rod extends downwards, and the lower end of the limit rod is connected to a limit sleeve; one end of the upper driving plate is connected to the lantern ring, and the other end of the upper driving plate is connected to the upper lip; one end of the lower driving plate is connected to the lantern ring, and the other end of the lower driving plate is connected to the lower lip; and the upper lip and the lower lip are driven to open and close when the upper driving plate and the lower driving plate are driven by the telescopic motor to move.

2. The massager with better adsorption effect according to claim 1, wherein two mounting plates arranged at intervals are arranged at a front end of the lantern ring, a first rotation shaft is arranged between the two mounting plates, a movable plate is arranged on the first rotation shaft, the connecting rod is rotatably mounted on the first rotation shaft via the movable plate, and an upper end of the limit rod is movably mounted at lower ends of the mounting plates.

3. The massager with better adsorption effect according to claim 1, wherein the upper driving plate is mounted at an upper end of the lantern ring via a first arc-shaped mounting portion, and a side wall of the first arc-shaped mounting portion is rotatably mounted on an inner wall of the housing via a second rotation shaft.

4. The massager with better adsorption effect according to claim 3, wherein a first movable hole is arranged at the inner wall of the housing, a first mounting groove is arranged at the first arc-shaped mounting portion, one end of the second rotation shaft is mounted on the first mounting groove, and the other end of the second rotation shaft is movably inserted into the first movable hole.

5. The massager with better adsorption effect according to claim 1, wherein the lower driving plate is mounted at a lower end of the lantern ring via a second arc-shaped mounting portion, and a side wall of the second arc-shaped mounting portion is rotatably mounted on the inner wall of the housing via a third rotation shaft.

6. The massager with better adsorption effect according to claim 5, wherein a second movable hole is arranged at the inner wall of the housing, a second mounting groove is arranged at the second arc-shaped mounting portion, one end of the third rotation shaft is mounted on the second mounting groove, and the other end of the third rotation shaft is movably inserted into the second movable hole.

7. The massager with better adsorption effect according to claim 1, wherein an end of the upper driving plate extending to the upper lip inclines upwards from the inside to the outside, a first mounting slot for inserting the upper driving plate is arranged at an inner wall of the upper lip, and the upper driving plate is inserted into the first mounting slot and connected to the upper lip.

8. The massager with better adsorption effect according to claim 1, wherein an end of the lower driving plate extending to the lower lip inclines downwards from the inside to the outside, a second mounting slot for inserting the lower driving plate is arranged at an inner wall of the lower lip, and the lower driving plate is inserted into the second mounting slot and connected to the lower lip.

9. The massager with better adsorption effect according to claim 1, wherein a mounting jack for inserting and mounting the connecting rod is arranged at an inner wall of the soft tongue portion, and the connecting rod is inserted into the mounting jack and connected to the soft tongue portion.
